(19) United States
(12) Patent Application Publication
(10) Pub. No.: US 2020/0340588 A1
(43) Pub. Date: Oct. 29, 2020

(54) SEALING DEVICE AND METHOD FOR MAKING SLINGER

(71) Applicant: NOK CORPORATION, Tokyo (JP)

(72) Inventor: Yuta KASAI, Fujisawa (JP)

(21) Appl. No.: 16/958,901

(22) PCT Filed: Aug. 9, 2019
(86) PCT No.: PCT/JP2019/031688

§ 371 Date: Jun. 29, 2020

(30) Foreign Application Priority Data
Aug. 23, 2018 (JP) 2018-155916

(51) Int. Cl. F16J 15/3256

(52) U.S. Cl. CPC F16J 15/3256

(57) ABSTRACT

A sealing device includes a slinger and a seal portion, wherein: a plurality of thread grooves, running parallel to each other, are formed on the outer surface of the flange portion of the slinger so as to extend in a radial outward direction from starting points located at a plurality of radial inner positions arranged in a ring around the crankshaft in order to return lubricating oil to the inside; and a distance between externally open ends of each of the plurality of thread grooves is greater than a distance between adjacent thread grooves on an imaginary surface of the flange portion passing through the rotary shaft and perpendicularly intersecting the flange portion.

### CROSS REFERENCE TO RELATED APPLICATIONS

This application is a U.S. National Phase application of International Application No. PCT/JP2019/031688, filed on Aug. 9, 2019 and published in Japanese as WO2020/039982 on Feb. 27, 2020 and claims priority to Japanese Patent Application No. 2018-155916, filed on Aug. 23, 2018. The entire disclosures of the above applications are expressly incorporated by reference herein.

### BACKGROUND

### Technical Field

The present invention relates to a sealing device comprising a slinger and a seal portion, and a method for making a slinger.

### Related Art

In general, in an engine for an automobile or the like, a sealing device is provided between the housing and the crankshaft as an oil seal for the engine in order to prevent lubricating oil that is sealed inside from leaking to the outside.

Such sealing devices are provided with a seal portion and a slinger, which rotates together with the rotation of the crankshaft. Thread grooves provided in a flange portion of the slinger return, to the inside, lubricating oil that has been discharged to the outside during the rotation of the crankshaft. However, if the rotation speed of the crankshaft rises, then the sealing properties of the seal portion are lowered.

Therefore, J P 2018-91372 A, which is an example of the conventional art, discloses a sealing device comprising: a slinger having a cylindrical portion that is attached to the outer circumferential surface of a crankshaft that rotates with respect to a housing, and an annular flange portion that extends from an inner end portion of the cylindrical portion in a direction perpendicular to the axis of the crankshaft; and a seal portion having a main lip that is attached to the housing and that seals lubricating oil inside the housing by slidably contacting the outer surface of the flange portion of the slinger; wherein, on an outer surface of the flange portion that comes into contact with the main lip, a discharging thread portion is formed for providing a discharging function to return lubricating oil to the inside of the housing during rotation, and an intake portion, facing in the direction opposite to the discharging thread portion, is formed for weakening the discharging function, thereby allowing the leakage of lubricating oil from the inside to the outside to be prevented, even during high-speed rotation of a rotary shaft.

According to the above-mentioned conventional art, it is possible to prevent lubricating oil leaking from the inside to the outside even during high-speed rotation of the rotary shaft. However, a technology that is able to maintain the sealing properties even when the rotary shaft is rotating at higher speeds is sought.

The present invention was made in view of the above, and an objective thereof is to provide a technology that can prevent the leakage of lubricating oil from the inside to the outside even when the rotary shaft is rotating at higher speeds.

### SUMMARY

The present invention, which solves the above-mentioned problem and achieves the objective, is a sealing device comprising: a slinger having a cylindrical portion that is attached to an outer circumferential surface of a rotary shaft that rotates relative to a housing, and an annular flange portion that extends from an inner end of the cylindrical portion in a direction perpendicular to an axis of the rotary shaft; and a seal portion that is attached to the housing, and that has a main lip slidably contacting an outer surface of the flange portion of the slinger, thereby sealing lubricating oil inside the housing; wherein a plurality of thread grooves, running parallel to each other, are formed on the outer surface of the flange portion so as to extend in a radial outward direction from starting points located at a plurality of radial inner positions arranged in a ring around the rotary shaft in order to return lubricating oil to the inside; and a distance between externally open ends of each of the plurality of thread grooves is greater than a distance between adjacent thread grooves on an imaginary surface of the flange portion passing through the rotary shaft and perpendicularly intersecting the flange portion.

Additionally, the present invention is a method for making a slinger having a cylindrical portion that is attached to an outer circumferential surface of a rotary shaft that rotates relative to a housing, and an annular flange portion that extends from an inner end of the cylindrical portion in a direction perpendicular to an axis of the rotary shaft, wherein thread grooves for returning lubricating oil to an inside are formed on an outer surface of the flange portion, the method for making a slinger including steps of: forming the thread grooves by pressing, using a die having a plurality of protrusions for forming the thread grooves; and setting a distance between externally open ends of each of the plurality of thread grooves to be greater than a distance between adjacent thread grooves on an imaginary surface of the flange portion passing through the rotary shaft and perpendicularly intersecting the flange portion.

In the method for making a slinger as mentioned above, it is preferable for the shapes of cross-sectional profiles of tips of the plurality of protrusions for forming the thread grooves to be curved shapes that gradually recede, on both sides, from a protruding central portion.

### Effects of Invention

The present invention provides the effect that the leakage of lubricating oil from the inside to the outside can be prevented even when the rotary shaft is rotating at higher speeds.

### BRIEF DESCRIPTION OF THE DRAWINGS

FIG. 1 is a section view indicating the attachment state of an oil seal, which is a sealing device according to an embodiment.

FIG. 2 is a plan view in which a slinger is observed from the direction of an outer surface.

FIG. 3 is a diagram illustrating an enlarged cross section of the outer surface of a flange portion at a portion of A-A in FIG. 2.

FIG. 4A is a first diagram for explaining a pressing procedure.

FIG. 4B is a second diagram for explaining the pressing procedure.

FIG. 4C is a third diagram for explaining the pressing procedure.

FIG. 5A is a diagram illustrating a first modified example of a press die.

FIG. 5B is a diagram illustrating a second modified example of a press die.

FIG. 6 is a diagram for explaining the relationship between a gap and the pressure of lubricating oil between a main lip and a slinger.

### DETAILED DESCRIPTION

Embodiments of the present invention will be explained below with reference to the drawings.

However, the present invention is not to be interpreted in a limiting manner by the descriptions of the embodiments below.

### Embodiments

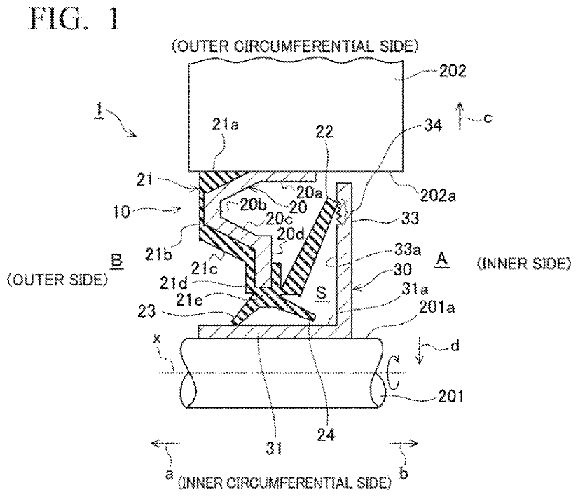

FIG. 1 is a section view indicating the attachment state of an oil seal 1, which is a sealing device according to the present embodiment.

The oil seal 1 illustrated in FIG. 1 is provided between a crankshaft 201 and a housing 202.

Additionally, the oil seal 1 illustrated in FIG. 1 comprises a seal portion 10 and a slinger 30, and prevents the entry of foreign matter from the outside B to the inside A, while also preventing the leakage of lubricating oil from the inside A to the outside B.

In FIG. 1, the direction indicated by the arrow a, in other words, the direction towards the outside B, is defined as the outer side; the direction indicated by the arrow b, in other words, the direction towards the inside A, is defined as the inner side; the direction indicated by the arrow c is defined as the outer circumferential side; and the direction indicated by the arrow d is defined as the inner circumferential side.

### Structure of Sealing Device

First, the seal portion 10 will be explained, and the slinger 30 will be described afterwards.

The seal portion 10 comprises a reinforcing ring 20 and an elastic portion 21.

The reinforcing ring 20 and the elastic portion 21 are integrally formed.

Additionally, the seal portion 10 is attached to the inner circumferential surface 202a, which is the surface on the inner circumferential side (the direction of the arrow d) of the housing 202.

The reinforcing ring 20 is a metallic ring centered at the axis x of the crankshaft 201.

Examples of the material of the reinforcing ring 20 include stainless steel and cold-rolled steel (SPCC).

Additionally, the reinforcing ring 20 can be molded by pressing or forging.

The elastic portion 21 is a substantially annular elastic member centered on the axis x of the crankshaft 201.

Examples of the material of the elastic portion 21 include synthetic rubber.

Examples of synthetic rubber include nitrile rubber (NBR), hydrogenated nitrile rubber (H-NBR), acrylic rubber (ACM), and fluororubber (FKM).

Additionally, the elastic portion 21 can be molded by means of crosslinking, using a mold.

In that case, the reinforcing ring 20 is placed inside the mold, the elastic portion 21 is joined to the reinforcing ring 20 by crosslinking, and the reinforcing ring 20 and the elastic portion 21 are integrally formed.

The reinforcing ring 20 comprises a cylindrical portion 20a, an outer circumferential disc portion 20b, a tapered portion 20c, and an inner circumferential disc portion 20d. The cylindrical portion 20a, the outer circumferential disc portion 20b, the tapered portion 20c, and the inner circumferential disc portion 20d are integrally formed.

The cylindrical portion 20a is a cylindrical part that extends substantially parallel to the axis x, and is fit so as to be in contact with the inner circumferential surface 202a of the housing 202.

The outer circumferential disc portion 20b is a hollow disc-shaped part that extends in a direction substantially perpendicular to the axis x, in other words, from the outer (the direction of the arrow a) end of the cylindrical portion 20a towards the inner circumferential side (the direction of the arrow d).

The tapered portion 20c is a hollow disc-shaped part that extends from the inner circumferential (the direction of the arrow d) end of the outer circumferential disc portion 20b further towards the inner circumferential side (the direction of the arrow d) and the inner side (the direction of the arrow b).

The inner circumferential disc portion 20d is a hollow disc-shaped part that extends from the inner circumferential (the direction of the arrow d) end of the tapered portion 20c further towards the inner circumferential side (the direction of the arrow d).

The cylindrical portion 20a may, in the unattached state, have a shape that slightly bulges towards the outer circumferential side (the direction of the arrow c).

The elastic portion 21, which comprises lip covering portions 21a, 21b, 21c, and 21d, a lip waist portion 21e, a main lip 22, a dust lip 23, and an intermediate lip 24, covers the reinforcing ring 20 from the outer side (the direction of the arrow a), from part of the outer circumferential side (the direction of the arrow c), and from the inner circumferential side (the direction of the arrow d), and is integrally formed on the reinforcing ring 20.

The lip covering portion 21a covers a portion of the outer circumferential side (the direction of the arrow c) on the cylindrical portion 20a of the reinforcing ring 20.

The lip covering portion 21b covers the outer circumferential disc portion 20b of the reinforcing ring 20 from the outer side (the direction of the arrow a).

The lip covering portion 21c covers the tapered portion 20c of the reinforcing ring 20.

The lip covering portion 21d covers the inner circumferential disc portion 20d of the reinforcing ring 20 from the outer side (the direction of the arrow a).

The lip waist portion 21e is a base portion for the main lip 22, the dust lip 23, and the intermediate lip 24 located near the inner circumferential (the direction of the arrow d) end of the inner circumferential disc portion 20d of the reinforcing ring 20.

The main lip 22, which is an annular lip part that extends from the inner (the direction of the arrow b) end of the lip waist portion 21e further towards the inner side (the direction of the arrow b) and the outer circumferential side (the direction of the arrow c), is formed so that the diameter becomes greater from the inner circumferential side (the direction of the arrow d) towards the outer circumferential side (the direction of the arrow c), and prevents the leakage of lubricating oil from the inside A to the outside B.

The dust lip 23, which is an annular lip part that extends from the inner circumferential (the direction of the arrow d) end of the lip waist portion 21e towards the outer side (the direction of the arrow a) and the inner circumferential side (the direction of the arrow d), is formed so that the diameter becomes greater from the outer circumferential side (the direction of the arrow c) towards the inner circumferential side (the direction of the arrow d), and prevents the entry of foreign matter from the outside B to the inside A.

As illustrated in FIG. 1, the direction of extension of the dust lip 23 is substantially opposite to the direction of extension of the main lip 22.

The intermediate lip 24 is an annular lip part that is located, on the lip waist portion 21e, on the inner circumferential side (the direction of the arrow d) relative to the main lip 22 and on the inner side (the direction of the arrow b) relative to the dust lip 23, in other words, at an intermediate location between the two lips, and that slightly extends from the inner circumferential (the direction of the arrow d) end of the lip waist portion 21e towards the inner side (the direction of the arrow b). The intermediate lip 24 serves as an oil-collecting lip that catches lubricating oil and prevents the lubricating oil from directly reaching the dust lip 23.

The intermediate lip 24 has a short lip length, and the tip of the lip is provided so as not to come into contact with the slinger 30.

An annular closed space S, surrounded by the main lip 22, the dust lip 23, the outer circumferential surface 31a of the cylindrical portion 31, and the outer surface 33a of the flange portion 33, is formed in the oil seal 1.

In the space S, lubricating oil that leaks from the inside A by passing between the outer surface 33a of the flange portion 33 of the slinger 30 and the tip of the main lip 22 is collected.

The lubricating oil collected in the space S is kept from leaking to the outside B by the intermediate lip 24.

Next, the slinger 30 will be explained.

The slinger 30 is attached to the outer circumferential surface 201a, which is the surface on the outer circumferential (the direction of the arrow c) side of the crankshaft 201, which is a rotary shaft that rotates relative to the housing 202.

The slinger 30 comprises a cylindrical portion 31 and an annular flange portion 33.

The slinger 30, in a state of attachment to the crankshaft 201, rotates together with the rotation of the crankshaft 201.

The cylindrical portion 31 is a cylindrical part that extends in a direction substantially parallel to the axis x, and is attached by being press-fitted and fixed so as to be in contact with the outer circumferential surface 201a of the crankshaft 201.

The entry of foreign matter from the outside B to the inside A is prevented by the tip of the dust lip 23 being in slidable contact with the outer circumferential surface 31a, which is the surface on the outer circumferential (the direction of the arrow c) side of the cylindrical portion 31.

The flange portion 33 is a hollow disc-shaped part that extends in the direction perpendicular to the axis x from the inner (the direction of the arrow b) end of the cylindrical portion 31 towards the outer circumferential side (the direction of the arrow c).

The flange portion 33 has an outer surface 33a, which is a surface on the outer side (the direction of the arrow a), and the tip of the main lip 22 slidably contacts this outer surface 33a, thus providing a seal and thereby preventing the leakage of lubricating oil from the inside A to the outside B.

Although the flange portion 33 illustrated in FIG. 1 is provided in the direction perpendicular to the axis x, the present invention is not limited thereto, and the flange portion 33 may be inclined relative to the axis x.

Thus, the oil seal 1 illustrated in FIG. 1 has a structure that prevents the entry of foreign matter by having the dust lip 23, which contacts the outer circumferential surface 31a of the cylindrical portion 31, disposed on the side towards the outside B, while also preventing the leakage of lubricating oil by having the main lip 22, which contacts the outer surface 33a of the flange portion 33, disposed on the side towards the inside A.

In this structure, the arrangement of the lips contacting the slinger, on the side towards the outside A and the side towards the outside B, is the opposite of that in a hub seal used in a hub bearing, and the functions thereof are also the opposite. Thus, the structure is fundamentally different from that in a hub seal.

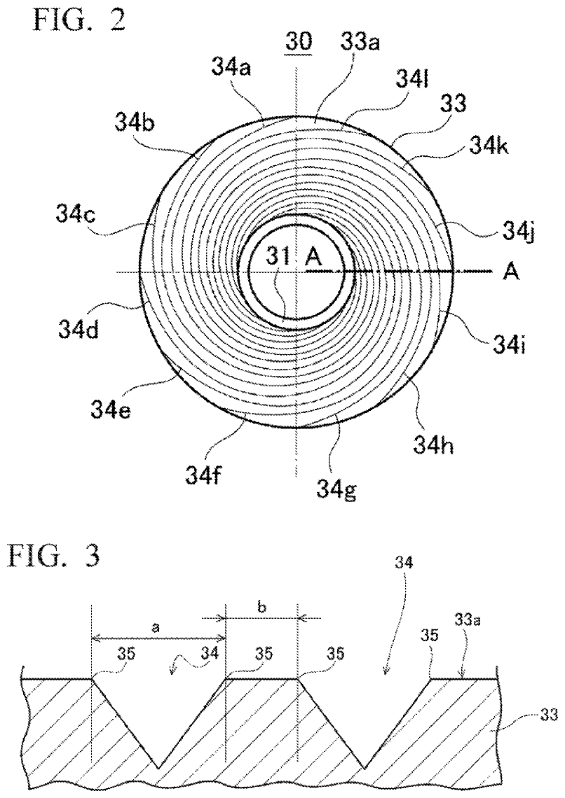

FIG. 2 is a plan view in which the slinger 30 is observed from the direction of the outer surface 33a.

As illustrated in FIG. 2, the outer surface 33a is provided with a plurality of parallel-running thread grooves, extending in spiral form, that serve a pumping function in the radially outward direction.

The plurality of thread grooves 34 are a collective term for the thread grooves 34a, 34b, 34c, 34d, 34e, 34f, 34g, 34h, 34i, 34j, 34k, and 34l.

The plurality of thread grooves 34 have starting points at a plurality of radial inner positions that are arranged in a ring around the rotary shaft, the starting points being disposed at positions separated from each other by approximately the same distance, and the ending points thereof are also provided at positions separated from each other by approximately the same distance.

The plurality of thread grooves 34 are each formed in a spiral that makes approximately one circuit from the starting point to the ending point. However, the present invention is not limited thereto, and may be formed in a spiral that covers less than one circuit from the starting point to the ending point, or may be formed in a spiral that covers one circuit or more.

The shapes of the plurality of thread grooves 34 are not limited to a spiral form, and the plurality of thread grooves 34 may be provided in radial form from the inner radial side to the outer radial side.

Additionally, the plurality of thread grooves 34 illustrated in FIG. 2 are formed so that the radius gradually becomes larger towards the right from the inner radial side to the outer radial side of the outer surface 33a of the flange portion 33, and there are twelve of the thread grooves 34.

However, the number of thread grooves provided on the outer surface of the flange portion in the present invention is not limited thereto, and is preferably as large as possible.

In this case, the rotation direction of the slinger 30 is to the left, which is the opposite of the direction of formation of the thread grooves 34.

FIG. 3 is a diagram illustrating an enlarged cross section of the outer surface 33a of the flange portion 33 at a portion of A-A in FIG. 2.

The cross section illustrated in FIG. 3 is an imaginary surface of the flange portion 33 that passes through the rotary shaft and that perpendicularly intersects the flange portion 33.

As illustrated in FIG. 3, the distance a between the externally open ends 35 of each of the plurality of thread grooves 34 is greater than the distance b between the plurality of thread grooves 34 that are adjacent to each other.

The open ends 35 are the starting points of slopes formed on both ends of each of the plurality of thread grooves 34 and are the edges of each of the plurality of thread grooves 34.

Additionally, the areas between the plurality of thread grooves 34 are the thickest parts of the flange portion 33, and are flat in FIG. 3.

The plurality of thread grooves 34 illustrated in FIG. 3 have cross-sectional shapes having two sloped surfaces that slope straightly from positions separated from each other and meet. However, the thread grooves provided in the flange portion in the present invention are not limited thereto, and they may be rounded.

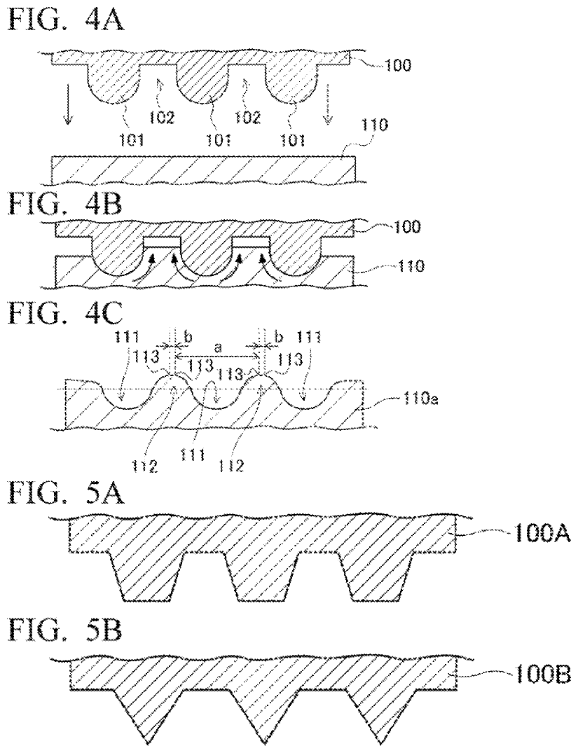

Additionally, the areas between the externally open ends 35 of each of the plurality of thread grooves 34 are flat. However, the shapes of the areas between the externally open ends 35 of each of the plurality of thread grooves 34 in the present invention are not limited thereto, and the shapes of the areas between the externally open ends 35 of each of the plurality of thread grooves 34 in the present invention may be pointed shapes provided with protrusions, or may be rounded as illustrated in FIG. 4C.

### Thread Groove Formation Method

Next, a method for making a slinger in which a plurality of thread grooves are formed, as in the slinger 30, will be explained.

As examples of the method for forming the plurality of thread grooves in a slinger, there are various working methods such as cutting. However, in this case, the method for forming the plurality of thread grooves by means of pressing will be explained in consideration of mass producibility.

In this case, a workpiece that is to form a slinger in which a plurality of thread grooves are formed, in the state before being pressed, will be referred to as a workpiece 110, the die used for pressing will be referred to as a press die 100, and the workpiece in the state after being pressed will be referred to as a workpiece 110a.

Additionally, the number of thread grooves to be formed will be three in order to simplify the explanation.

FIG. 4A is a first diagram for explaining the pressing procedure.

The press die 100 illustrated in FIG. 4A has a plurality of die protrusions 101 with rounded tips, and die recesses 102 provided between the plurality of die protrusions 101.

The press die 100, which has been lowered in the direction of the arrow shown in FIG. 4A, is pressed against the workpiece 110.

The plurality of die protrusions 101 are protrusions for forming thread grooves, and the shapes of cross-sectional profiles of the tips thereof are curved shapes that gradually recede, on both sides, from a protruding central portion.

FIG. 4B is a second diagram for explaining the pressing procedure.

As illustrated in FIG. 4B, when the press die 100 is pressed against the workpiece 110, the die protrusions 101 enter into the workpiece 110, and the die protrusions 101 cause the metallic material of the workpiece 110 to be pushed to the sides of the die protrusions 101 as illustrated by the arrows.

FIG. 4C is a third diagram for explaining the pressing procedure.

As illustrated in FIG. 4C, workpiece recesses 111 and workpiece protrusions 112 are formed in the post-working workpiece 110a that has been pressed by the press die 100.

Due to the die protrusions 101 pushing the metallic material of the workpiece 110 to the sides of the workpiece recesses 111, the sides of the workpiece recesses 111 are made to rise upwards to form the workpiece protrusions 112. Thus, the workpiece recesses 111 are smoothly formed.

The workpiece 110a that is pressed in this way forms the slinger, and the workpiece recesses 111 form the plurality of thread grooves.

Additionally, externally open ends 113 are provided on the workpiece recesses 111, and the open ends 113 are separated by the distance a.

In this case, the vertices of the workpiece protrusions 112, which are in the form of peaks, are provided between the plurality of thread grooves, and at this time, the regions within the distance b are small regions of the vertices, and the distance b is approximately zero.

Therefore, by using the formation method explained with reference to FIG. 4A to FIG. 4C, it is possible to make the distance a between the externally open ends of the plurality of thread grooves larger than the distance b between the plurality of thread grooves that are adjacent to each other.

As explained above, the lubricating oil can be prevented from leaking from the inside to the outside, even when the rotary shaft is rotating at higher speeds.

The press die 100 illustrated in FIG. 4A to FIG. 4C can smoothly form a plurality of thread grooves by the die protrusions 101 pushing the metallic material of the workpiece 110 to the sides of the die protrusions 101, and the shape is a preferable shape in which the tips do not tend to wear down during the pressing procedure.

However, the press die used in the present invention is not limited to the shape illustrated in FIG. 4A to FIG. 4C.

### Modified Example of Press Die

FIG. 5A is a diagram illustrating a first modified example of the press die.

When making the slinger in accordance with the present embodiment, it is also possible to use die protrusions having flat tips, as in the press die 100A illustrated in

FIG. 5A.

FIG. 5B is a diagram illustrating a second modified example of the press die.

When making the slinger in accordance with the present embodiment, it is also possible to use die protrusions having pointed tips, as in the press die 100B illustrated in FIG. 5B.

Thus, a plurality of thread grooves 34 can be formed on the slinger 30 by means of a pressing procedure, thereby allowing a slinger 30 provided with a plurality of thread grooves 34 to be made with high productivity.

### Functions and Effects of Sealing Device

In FIG. 1, when the slinger 30 and the crankshaft 201 are rotated, a gap corresponding to the pressure is formed between the main lip 22 and the slinger 30.

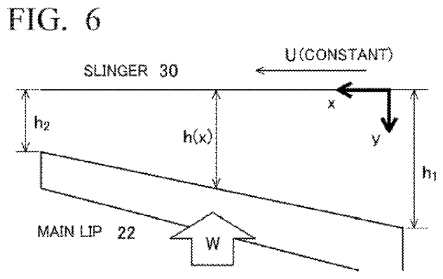

FIG. 6 is a diagram for explaining the relationship between the gap and the pressure of the lubricating oil between the main lip 22 and the slinger 30.

In FIG. 6, h(x) represents the size of the gap at the position x, and W represents the return force of the main lip 22.

A relationship represented by the Reynolds equation in Equation (1) below arises between the pressure p between the main lip 22 and the slinger 30, the position x, the size h of the gap, the constant axial speed U of the rotary shaft, and the viscosity η of the lubricating oil.

$$\begin{matrix}Math . 1 & \\ \frac{d}{dx} ( \frac{{h}^{3}}{12 η} \frac{dp}{dx} ) = \frac{U}{2} \frac{dh}{dx} & ( 1 )\end{matrix}$$

According to Equation (1) above, the larger the size h of the gap, the lower the pressure p becomes.

Furthermore, in FIG. 6, h₁>h₂. Thus, the pressure p₁ at the part with a gap size h₁ is lower than the pressure p at the part with a gap size h₂. In other words, p₁<p₂.

In this case, the gap h(groove) at the parts with thread grooves, extending over the distance a, will be larger, by the depth of the thread grooves, than the gap h(between grooves) at the parts between thread grooves, extending over the distance b. Thus, h(groove)>h(between grooves).

For this reason, the pressure p(groove) at the parts with the thread grooves is lower than the pressure p(between grooves) at the parts between the thread grooves, so p(groove)<p(between grooves).

Therefore, as the size of the parts between the thread grooves becomes larger, the pressure of the lubricating oil between the main lip 22 and the slinger 30 becomes higher, making the size of the gap between the main lip 22 and the slinger 30 larger.

Furthermore, as the size of the gap becomes larger, the lubricating oil discharging effect due to the thread grooves is lowered, and the sealing properties are also lowered.

Therefore, by making the distance a between the externally open ends of each of the plurality of thread grooves larger than the distance b between the plurality of thread grooves, and reducing the size of the gap between the main lip 22 and the slinger 30, it is possible to improve the sealing properties.

According to the present embodiment, it is possible to prevent the lubricating oil from leaking from the inside to the outside, even when the rotary shaft is rotating at higher speeds.

Furthermore, according to the present embodiment, it is possible to prevent the leakage of lubricating oil from the inside to the outside without raising the torque.

Additionally, according to the present embodiment, it is possible to make, with high productivity, by means of a pressing procedure, a die for a sealing device that can prevent lubricating oil from leaking from the inside to the outside, even when the rotary shaft is rotating at higher speeds.

The range of application of the present invention is not limited to the engines of automobiles and the like, and the present invention can be applied to vehicles other than automobiles, general-purpose machinery, industrial machines, and the like, for example, to transmissions, speed reducers, motors, differential mechanisms.

1. A sealing device comprising:
a slinger having a cylindrical portion that is attached to an outer circumferential surface of a rotary shaft that rotates relative to a housing, and an annular flange portion that extends from an inner end of the cylindrical portion in a direction perpendicular to an axis of the rotary shaft; and
a seal portion that is attached to the housing, and that has a main lip slidably contacting an outer surface of the flange portion of the slinger, thereby sealing lubricating oil inside the housing; wherein
a plurality of thread grooves, running parallel to each other, are formed on the outer surface of the flange portion so as to extend in a radial outward direction from starting points located at a plurality of radial inner positions arranged in a ring around the rotary shaft in order to return lubricating oil to the inside; and
a distance between externally open ends of each of the plurality of thread grooves is greater than a distance between adjacent thread grooves on an imaginary surface of the flange portion passing through the rotary shaft and perpendicularly intersecting the flange portion.

2. A method for making a slinger having a cylindrical portion that is attached to an outer circumferential surface of a rotary shaft that rotates relative to a housing, and an annular flange portion that extends from an inner end of the cylindrical portion in a direction perpendicular to an axis of the rotary shaft, wherein thread grooves for returning lubricating oil to an inside are formed on an outer surface of the flange portion, the method for making a slinger including steps of:
forming the thread grooves by pressing, using a die having a plurality of protrusions for forming the thread grooves; and
setting a distance between externally open ends of each of the plurality of thread grooves to be greater than a distance between adjacent thread grooves on an imaginary surface of the flange portion passing through the rotary shaft and perpendicularly intersecting the flange portion.

3. The method for making a slinger according to claim 2, wherein the shapes of cross-sectional profiles of tips of the plurality of protrusions for forming the thread grooves are curved shapes that gradually recede, on both sides, from a protruding central portion.
